(19) United States
(12) Patent Application Publication
(10) Pub. No.: US 2008/0124091 A1
(43) Pub. Date: May 29, 2008

(54) Reduction of Signal Degradations in Optical Transmission Links

(75) Inventors: Sascha Vorbeck, Darmstadt (DE); Malte Schneiders, Darmstadt (DE); Ralph Leppla, Darmstadt (DE)

Correspondence Address: KENYON & KENYON LLP, ONE BROADWAY, NEW YORK, NY, 10004, US

(73) Assignee: DEUTSCHE TELEKOM AG, Bonn (DE)

(21) Appl. No.: 11/547,327

(22) PCT Filed: Mar. 3, 2005
(86) PCT No.: PCT/DE05/00356

§ 371 Date: Oct. 9, 2007

(30) Foreign Application Priority Data
Apr. 1, 2004 (DE) 10 2004 016 198.4

(51) Int. Cl. H04B 10/00; H04B 10/18

(52) U.S. Cl. 398/152; 398/158

(57) ABSTRACT

Methods, devices and/or systems are provided for reducing signal degradations in optical transmission links. A means for ensuring a flexible manipulation for the improvement of an optical signal, especially during operation, is provided in a simple and cost-effective manner. To this end, a signal degradation in an optical transmission link is reduced by at least partially compensating a chromatic dispersion and a polarization mode dispersion of an optical signal, by adapting the temperature of a dispersion compensation device coupled into the transmission link.

### FIELD OF THE INVENTION

The present invention relates to methods, devices or systems for reducing signal degradations in optical transmission links.

### BACKGROUND INFORMATION

In working with optical communication or transmission links, a dispersion, thus the widening of an optical signal pulse over time in the course of the transmission through an optical fiber, can lead to a signal degradation and, as a result, a signal distortion and bit errors at the receiver.

The chromatic dispersion and the polarization mode dispersion may be attributed essentially to specific material properties of the optical fiber. The chromatic dispersion is based substantially on a change in the refractive index of the optical fiber material used, e.g., silicate glass, as a function of the wavelength, which means pulses having a narrower half width (broader spectrum) are widened more significantly by the dispersion than pulses having a larger half width (narrower spectrum). The polarization mode dispersion is based essentially on a change of the refractive index in merely one dimension in response to mechanical irregularities, e.g., due to bends, pressure, tension and/or temperature of the optical fiber, one of the orthogonal polarization modes being transmitted faster than the other.

When working with optical systems having a high bit rate, such as in the case of DWDM (dense wavelength division multiplex) systems, such dispersions may have an especially negative effect on the bandwidth, the length of the transmission link and/or the transmission rate.

Therefore, to compensate for the chromatic dispersion, dispersion compensating fibers (DCF) or optical fiber gratings (Bragg grating) have been used. DCFs are used practically exclusively in the optical communication systems. The accumulated dispersion, which can be offset by the DCFs, is a function of the parameters and the length of the DCF, and as a rule, is constant. There are several approaches and compensators by which the chromatic dispersion, hereinafter also known as CD, can be adaptively regulated as well. All-pass filters and optical fiber gratings can be cited here as example.

With regard to the compensation of polarization mode dispersion, hereinafter also known as PMD, all optical compensators are based essentially on a cascading arrangement of polarization setting elements which alter the polarization of the incident light, and subsequent double-refractive fibers or crystals. In this context, the differential group delay (DGD), which is a physical property of the fiber and of the crystal and which leads to PMD and thus to signal distortion, may be fixed or variable. These elements are cascaded repeatedly, depending upon the desired complexity and powerfulness of the compensators, and are able to partially compensate for the signal distortions which have developed during a transmission via a glass fiber. In addition to the optical compensators, electrical compensators have already been presented as well, which attempt to improve the signal quality after the optical-electrical conversion. To determine the manipulated variables of the compensators, most compensators are provided with a feedback loop which assess and optimize the signal quality based on the settings of the compensator. At present, these compensators are still in the test stage, and only an optical compensator for a low data rate of 10 Gbit/s is commercially available.

Therefore, using the existing concepts, at least two compensators, one for the CD and one for the PMD, must always be used to improve the signal quality. This procedure is linked both to higher costs and to a higher insertion loss which leads to a perceptible signal deterioration due to accumulated noise, especially for systems having a high bit rate. When using a CD and a PMD compensator, thus a two-stage compensator, having a variable delay line, a minimal number of 4 degrees of freedom must further be taken into account and adjusted by a costly control in order to improve the signal.

Moreover, for the adaptive compensation of the CD and PMD, under the state of the art it can be necessary to provide additional, particularly also optical compensators or subcomponents, and to incorporate them into the system, which is associated with a high financial expenditure.

### SUMMARY OF INVENTION

Embodiments of the present invention provide a means that is novel and substantially improved compared to the related art indicated above, by which, in a simple and cost-effective manner, a flexible manipulation is ensured to improve an optical signal, especially during continuous operation as well.

According to embodiments of the present invention, to reduce a signal degradation in an optical transmission link, it is provided to at least partially compensate for a chromatic dispersion (CD) and a polarization mode dispersion (PMD) of an optical signal by adjusting the temperature of a dispersion compensation device coupled into the transmission link. Consequently, embodiments of the present invention may provide a multitude of advantages compared to the previous compensation of the CD and the PMD, which was always accomplished separately for each. And, the number of components necessary under the state of the art may be reduced substantially, since using the present invention, one compensator acting essentially merely on the basis of a temperature adjustment or variation now can be already sufficient to at least partially compensate for both the chromatic dispersion and the polarization mode dispersion, and as a result, to reduce the degradation of an optical transmitted signal.

In embodiments of the present invention, a glass fiber, e.g., a DCF, is used as a dispersion compensation device.

To basically always ensure optimal signal quality, especially even in the event of changing mechanical irregularities, it is provided to regulate an adjustment of the temperature of the dispersion compensation device in response to at least one parameter representing a signal degradation.

To implement an adaptive compensator that is suitable for this purpose and is regulated merely by the temperature, embodiments of the present invention provides a device for reducing signal degradation in an optical transmission link, which includes a dispersion compensation device that is able to be coupled into the transmission link and that is connected to a device for altering the temperature of the dispersion compensation device, as well as a regulator that is connected to the temperature alteration device for regulating the temperature of the dispersion compensation device and that is designed to at least partially compensate for a CD and a polarization mode dispersion of an optical signal as a function of at least one parameter representing a signal degradation.

Therefore, embodiments of the present invention may provide a device that, with the aid of adaptively regulated temperature changes in the dispersion compensation device, by temperature changes of a subcomponent of the transmission system, it is possible to both compensate for a CD and, in a further embodiment, also to effectively counteract the physical effects of the PMD.

This at least one parameter representing a signal degradation is expediently acquired directly on the receiver side, and is used as an actual value to be optimized for regulating the temperature adjustment. Consequently, an optical transmission system, including at least one device according to embodiments of the present invention allocated to an optical transmission link, and in a further embodiment, has at least one monitoring device, that is disposed on the receiver side of the transmission link and is connected to the regulator, for acquiring the at least one parameter representing a signal degradation and feeding it back as a feedback signal to the regulator.

In this context, for the cost-effective utilization of components already at hand, in a further refinement, it is provided to interconnect the monitoring device and the regulator via a monitoring channel assigned to the transmission link.

Particularly in view of the compensation of the PMD, it has proven to be advantageous to carry out the temperature-based compensation at a location in the optical transmission link at which the preceding average differential group delay difference and the following average differential group delay difference essentially correspond to each other. Therefore, in embodiments of the present invention, regardless of the length of the optical transmission fiber, the optimal effect can be ensured, similar to a temperature-dependent polarization setting element, using a dispersion compensation device which, in a further embodiment, is coupled in essentially halfway through the transmission link between transmitter and receiver.

Thus, embodiments of the present invention may be usable substantially independently of the modulation format and the data rate, and in further embodiments, may be attachable to subcomponents already present in the system. It is only necessary to retrofit the heating components for which, however, the financial expenditure is low, since here they are not sensitive optical components. Moreover, depending upon how the dispersion compensation is already realized in an existing system, the compensator according to the present invention may even be installed during continuous operation.

Further, a exemplary device of the present invention, essentially compensating simultaneously for the CD and PMD after suitable temperature adjustment, may possess only one final controlling element whose definition range, depending upon the specific embodiment and taking as a basis certain calculations and functional dependencies, can, in addition, be sharply reduced.

To this end, embodiments of the present invention may provide that a device be designed in such a way that a temperature range, within which the CD is compensated within specifiable limits, is established for the dispersion compensation device, and subsequently the minimization of a parameter representing the signal degradation as a result of PMD is regulated by altering the temperature within this temperature range.

In a further embodiment, the temperature range is preset, and a measure for the signal quality on the receiver side is used for the signal degradation as a result of PMD.

In another embodiment, two parameters, each directly connected to the physical effects of a CD or a PMD, are acquired on the receiver side and optimized one after another.

In another embodiment, the temperature range is calculated as a function of a parameter acquired on the receiver side and directly connected to the physical effects of a CD, and as a function of predefined boundary conditions, and a measure for the signal quality on the receiver side is used for the signal degradation as a result of PMD.

Suitable boundary conditions may include an allowed overcompensation and undercompensation, the signal data rate and/or specific parameters of the dispersion compensation device.

Depending on a specific existing optical transmission system and/or, for example, predefined parameters to be regulated specific to the application, it may be possible to fall back upon a plurality of different measured quantities for providing a feedback signal.

To measure the signal quality, monitoring devices may be designed to measure a BER, the number of corrected coding errors of an error protection coding, a Q factor and/or an eye pattern. Further measured quantities may be made available by monitoring devices that are designed to measure an accumulated dispersion, a degree of polarization and/or a power density spectrum.

### BRIEF DESCRIPTION OF THE DRAWINGS

FIG. 1 shows the measurement of the DGD at various times of day and therefore ambient temperatures.

FIG. 2 shows the signal degradation due to CD and PMD as a function of the temperature of a dispersion compensating fiber.

FIG. 3 shows an embodiment of the present invention having only one feedback signal.

FIG. 4 shows an embodiment of the present invention having one feedback signal for the signal distortions due to PMD, and one for the signal distortions due to CD.

FIG. 5 shows an embodiment of the present invention with calculation of ΔT_{CD} and regulation to the minimum signal degradation in the range ΔT_{PMD}.

### DETAILED DESCRIPTION

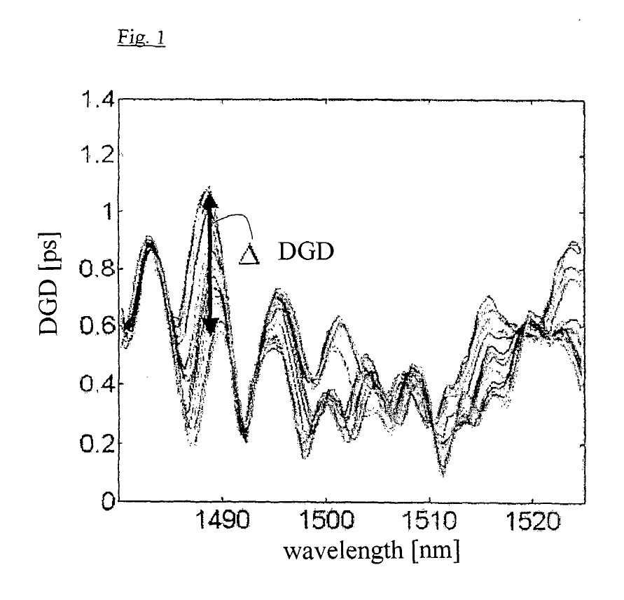

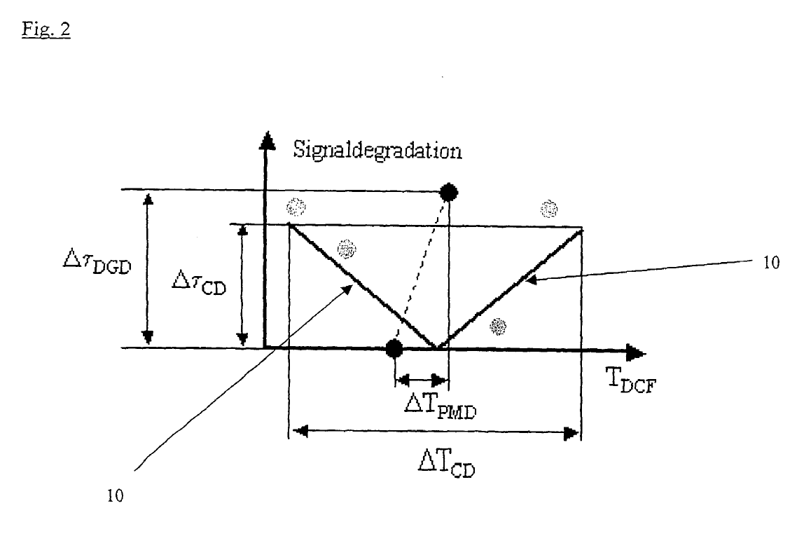

In the following, three exemplary embodiments of the present invention are described in detail, but only by way of example; the mode of operation of the invention is first discussed in detail with reference to FIGS. 1 and 2.

The mode of operation of some embodiments of the present invention is based essentially on the realization that both the CD and the PMD of a fiber can be manipulated via the temperature. In this context, it has turned out that the PMD reacts substantially more sensitively to a temperature change than the dispersion.

For the graphic view according to FIG. 1, the differential group delay DGD was measured at various times of day and therefore ambient temperatures. It can be seen that there is a strong dependency of the DGD on the temperature. For example, at a wavelength of approximately 1490 nm, such a temperature-sensitive dependency of the DGD is made clear by the double arrow denoted in FIG. 1 by ΔDGD

Moreover, it has turned out that a temperature-based change of the CD exhibits a strictly monotonic behavior, which does not exist in the case of the PMD. At a constant temperature, both the CD and the PMD of the fiber, and therefore also the signal quality, are nearly constant, especially on condition that further boundary conditions acting, e.g., mechanically acting, on the optical transmission fiber are essentially constant as well. Furthermore, since as a function of the data rate, the signal quality is still sufficiently good given a certain undercompensation (positive accumulated CD) or a certain overcompensation (negative accumulated CD), within a tolerance range it is not necessary to exactly compensate for the CD in an optical transmission system.

FIG. 2 shows the connection of the signal degradation due to CD and PMD. The signal degradation based on CD is a deterministic process and proceeds along the two lines denoted by 10. In response to a deviation from the optimal dispersion value because of a change of T_{DCF}—the temperature of the dispersion compensation device, especially a dispersion compensating fiber DCF—the signal degradation due to CD rises monotonically. If the PMD is disregarded, a temperature-dependent tolerance range ΔT_{CD} for the CD with a sufficiently small signal degradation is still very large. If, in addition to the CD, the PMD is also taken into account, a statistical signal degradation based on the PMD is superimposed on the monotonic characteristic of the signal degradation. As already discussed, in this case, small temperature fluctuations already lead to great changes in the signal degradation, shown in FIG. 1 by the two measuring points connected by the dashed line. As FIG. 2 further shows, a narrow temperature-dependent tolerance range ΔT_{PMD} with a minimal signal degradation can be found for the PMD in the tolerance range ΔT_{CD} of the CD. In this way, it is possible to minimize both the degradation because of the CD and the degradation because of the PMD using only the control variable T_{DCF}.

To permit a rapid, exact and homogeneous temperature change of the DCF, the DCF is therefore heated or cooled in a temperature chamber or using another suitable temperature-altering device. Based on specification sheets of fiber manufacturers, the glass fibers are already exposed to a minimum temperature of −60° C. and a maximum temperature of 85° C. at the quality controls, so that the possibility that the DCFs will be destroyed in the temperature chambers can be ruled out.

However, in comparison to the PMD of the transmission fiber, the DCF has considerably smaller PMD values because of the smaller length. Therefore, it may not be possible for the DCF to exactly simulate the transmission function of the transmission fiber in inverted fashion. Consequently, the DCF acts rather like a temperature-dependent polarization setting element which couples the signal into the next transmission fiber in such a way that the signal distortions due to PMD are minimized. Therefore, a compensator according to the present invention achieves the best results when, based on the system architecture, the distortions due to PMD upstream of the compensator can be eliminated again through the fiber sections downstream of the compensator. The compensator of the present invention should therefore be mounted at the location in the transmission system at which the average differential group delay difference upstream of the compensator corresponds to the average differential group delay difference downstream of the compensator. The measurement data necessary for regulating the temperature must thus be transported via half the transmission link to the regulator. This transfer may be carried out expediently via the monitoring channel of the transmission system (supervisory channel which, in an available manner, is already implemented in every transmission system for monitoring and controlling the network elements.

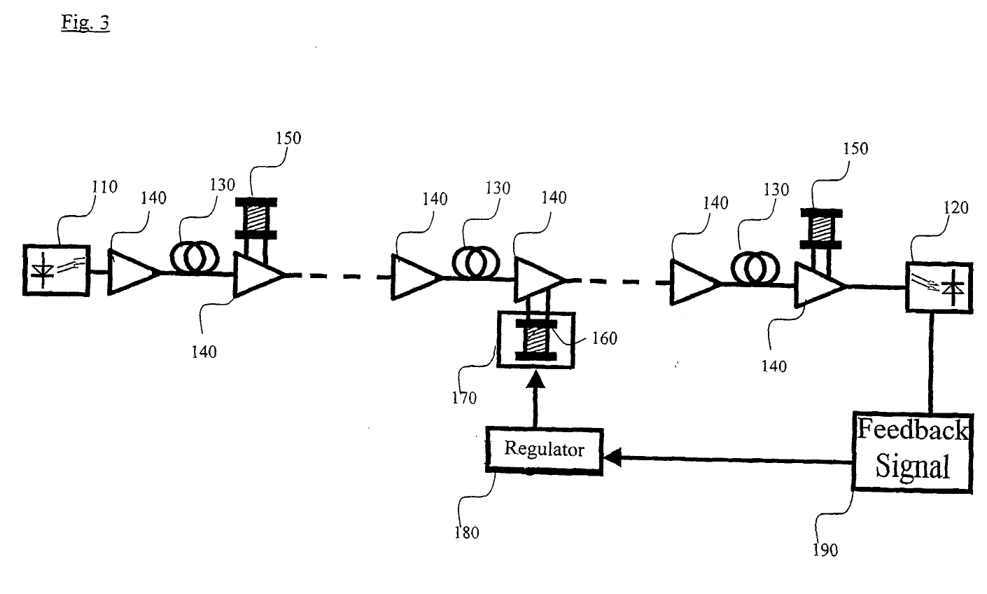

Three implementations of varied complexity for the simultaneous adaptive temperature-based compensation of the CD and the PMD are described in the following with reference to FIGS. 3 through 5. FIGS. 3 through 5 each show schematic representations of an optical transmission link between a transmitter 110 and a receiver 120. The transmission link includes a plurality of optical transmission fibers 130 of specific length, which are interconnected via amplifiers 140 for amplifying the signal. Moreover, a plurality of dispersion-compensating fibers 150, 160 are coupled via amplifiers 140 into the transmission link.

In terms of their properties, dispersion-compensating fibers 150 are rigid and, as a rule, already compensate for a large portion of chromatic dispersion. The dispersion-compensating fiber DCF denoted by reference numeral 160 is variable with respect to its temperature, and is part of the adaptive compensator according to the present invention, which therefore, in the examples shown, is used for further fine tuning in the compensation of the chromatic dispersion.

To alter the temperature, dispersion-compensating fiber 160 is disposed in a temperature chamber 170 whose temperature is regulated by a regulator 180. A monitoring device 190, connected to the transmission link on the receiver side, measures at least one parameter directly or indirectly representing a signal degradation, and supplies it again as feedback signal to the regulator.

In detail, in the implementation according to FIG. 3, for example, the signal quality measured at the end of the transmission link at receiver 120 is transmitted as feedback signal to the regulating unit. In so doing, for example, the signal quality may be determined in the form of a bit error rate (BER), the number of corrected coding errors of an error protection coding (forward error correction FEC), a Q factor or an eye pattern. Therefore, in this implementation, just one parameter is already sufficient as input parameter of the regulator, the adaptive temperature adjustment in this case preferably being carried out as follows.

The temperature range of DCF 160 is traversed during the initial operation, the range of optimum CD compensation ΔT_{CD} being determined as the wide maximum of the signal quality. The CD is offset with sufficient accuracy within this range, and fluctuations within the range can therefore be attributed to the influence of the PMD. Thus, in this small range, regulator 180 only has to set the working point with the minimal signal degradation.

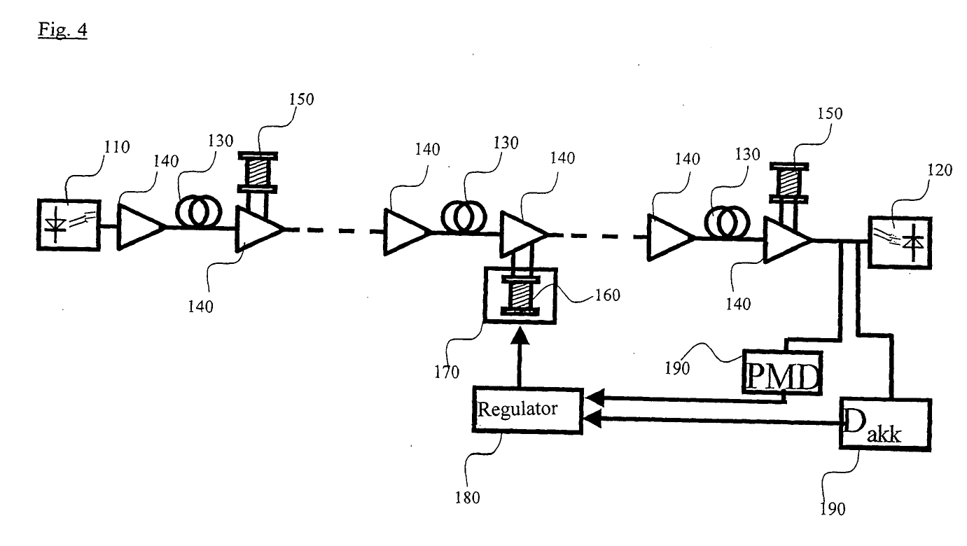

The implementation according to FIG. 4 is more complex compared to the first. In this implementation, regulator 180 is supplied with two input parameters which can be connected directly to the two physical effects CD and PMD, and therefore directly specify which effect must be even further offset.

Here, the accumulated dispersion Dₐₖₖ at the end of the fiber link provides a solution for monitoring the CD. In a first compensation step, the compensator is initially brought into operating range ΔT_{CD} by variation of the temperature, so that the remaining accumulated dispersion subsequently lies within the tolerance range of the transmission system.

The degree of polarization (DOP) or the power density spectrum of the signal (spectral hole burning), for example, may be used as input parameters of regulator 180 for monitoring the PMD. Completely polarized light has a DOP of 1, which corresponds to a signal undistorted by PMD of the first order. In the case of spectral hole burning, the signal distortion because of PMD may be minimized with the aid of the electrical spectrum. Within temperature range ΔT_{CD} with small signal distortions due to CD, the signal distortion due to PMD may now be regulated to a minimum in the ΔT_{PMD} range.

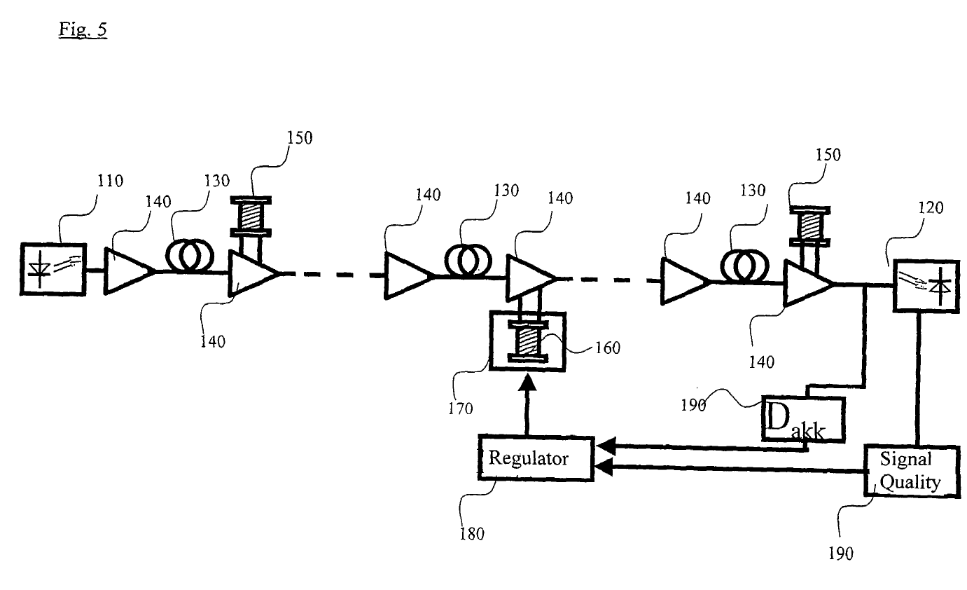

In the implementation according to FIG. 5, in a first step, instantaneous accumulated dispersion Dₐₖₖ is measured by a dispersion monitor 190. Subsequently, as a function of the allowed overcompensation and undercompensation, the data rate of the signal and the fiber parameters of DCF 160, regulator 180 calculates the temperature range ΔT_{CD} in which DCF 160 should find itself in order to achieve sufficiently good signal quality in relation to the dispersion. The change of dispersion parameter (D) with temperature (T) may preferably be calculated using the following formula derived from the Sellmeier equation of the third order

$$\underline{\frac{d D}{d T} = \frac{1}{4} ( λ - \frac{{λ}_{0}^{4}}{{λ}^{3}} ) \frac{d {S}_{0}}{d T} - \frac{{S}_{0} {λ}_{0}^{3}}{{λ}^{3}} \frac{d {λ}_{0}}{d T}}$$

where λ represents the wavelength, λ₀ represents the wavelength in the dispersion zero crossing, and S₀ represents the gradient in the dispersion zero crossing.

By rearranging the equation with respect to dT, inserting the allowed limits for the overcompensation and undercompensation, and the fiber parameters, it is possible to calculate ΔT_{CD}. Subsequently, regulator 180 controls temperature chamber 170 in such a way that allowed temperature range ΔT_{CD} is traversed from the minimum up to the maximum temperature. The DGD and the parameter of the signal quality pass through a plurality of maxima and minima during the traversal of the temperature range. During this process, the signal quality is measured and received by regulator 180. Based on the curves of the signal quality over the temperature, regulator 180 regulates the temperature of DCF 160 to the optimum value with the least signal degradation in the range ΔT_{PMD}. In this state, both the CD and the PMD are optimally compensated, and the signal quality is maximized. For this implementation, with the value of the accumulated dispersion and of the signal quality, two input parameters are obtained for the regulator.

1-19. (canceled)

20. A method for reducing a signal degradation in an optical transmission link, comprising:
providing a chromatic dispersion of an optical signal; and
providing a polarization mode dispersion of the optical signal,
wherein the chromatic dispersion and the polarization mode dispersion of the optical signal are compensated at least partially by adjusting the temperature of a dispersion compensation device coupled into the optical transmission link.

21. The method of claim 20, wherein the adjustment of the temperature of the dispersion compensation device is regulated in response to at least one parameter representing a signal degradation.

22. The method of claim 20, wherein the at least one parameter is acquired on the receiver side and is used as an actual value to be optimized for regulating the temperature adjustment.

23. The method of claim 20, wherein the temperature-based compensation is carried out at a location in the optical transmission link at which the preceding average differential group delay difference and the following average differential group delay difference essentially correspond to one another.

24. The method of claim 20, wherein a temperature range in which the chromatic dispersion is compensated within specifiable limits is set for the dispersion compensation device, and a minimum of a parameter representing a signal degradation as the result of polarization mode dispersion is set by altering the temperature within this temperature range.

25. The method of claim 20, wherein the temperature range is preset, and a measure for the signal quality on the receiver side is used for the signal degradation as a result of polarization mode dispersion.

26. The method of claim 24, wherein two parameters, each directly connected to the physical effects of one of a chromatic dispersion or a polarization mode dispersion, are acquired on the receiver side and optimized one after another.

27. The method of claim 24, wherein the temperature range is calculated as a function of a parameter, acquired on the receiver side and directly connected to the physical effects of a chromatic dispersion, and as a function of predefined boundary conditions, and a measure for the signal quality on the receiver side is used for the signal degradation as a result of polarization mode dispersion.

28. The method of claim 20, further comprising allowing an overcompensation and an undercompensation, wherein the signal data rate and/or specific parameters of the dispersion compensation device are predefined as boundary conditions.

29. The method of claim 20, wherein a glass fiber is used as a dispersion compensation device.

30. A device for reducing a signal degradation in an optical transmission link, comprising:
a dispersion compensation device which is able to be coupled into the transmission link and which is connected to a device for altering the temperature of the dispersion compensation device; and
a regulator which is connected to the temperature alteration device and which, to at least partially compensate for a chromatic dispersion and a polarization mode dispersion of an optical signal, regulates the temperature of the dispersion compensation device via the temperature alteration device as a function of at least one parameter representing a signal degradation.

31. The device of claim 30, wherein the device sets a temperature range, within which the chromatic dispersion can be compensated within specifiable limits, for the dispersion compensation device and within this temperature range alters the temperature to discover a minimum of a parameter representing a signal degradation as the result of polarization mode dispersion.

32. An optical transmission system, comprising:
at least one optical transmission link having a device including:
a dispersion compensation device which is able to be coupled into the transmission link and which is connected to a device for altering the temperature of the dispersion compensation device; and
a regulator which is connected to the temperature alteration device and which, to at least partially compensate for a chromatic dispersion and a polarization mode dispersion of an optical signal, regulates the temperature of the dispersion compensation device via the temperature alteration device as a function of at least one parameter representing a signal degradation.

33. The optical transmission system of claim 32, wherein the dispersion compensation device is coupled in essentially halfway through the transmission link of the system.

34. The optical transmission system of claim 32, further comprising at least one monitoring device, disposed on the receiver side of the transmission link and connected to the regulator, to acquire the at least one parameter representing a signal degradation and to feed it back as feedback signal to the regulator.

35. The optical transmission system of claim 34, wherein the monitoring device and the regulator are interconnected via a monitoring channel assigned to the transmission link.

36. The optical transmission system of claim 34, further comprising a monitoring device designed to measure a BER, the number of corrected coding errors of an error protection coding, a Q factor and/or an eye pattern.

37. The optical transmission system of claim 34, further comprising a monitoring device designed to measure the accumulated dispersion.

38. The optical transmission system of claim 34, further comprising a monitoring device designed to measure the degree of polarization or the power density spectrum.
